(19) United States
(12) Patent Application Publication
(10) Pub. No.: US 2025/0266553 A1
(43) Pub. Date: Aug. 21, 2025

(54) CELL-ACCOMMODATING MEMBER

(71) Applicant: Sumitomo Riko Company Limited, Aichi (JP)

(72) Inventors: Motoshige Hibino, Aichi (JP); Shigeo Nakanishi, Aichi (JP)

(73) Assignee: Sumitomo Riko Company Limited, Aichi (JP)

(21) Appl. No.: 19/203,105

(22) Filed: May 8, 2025

Related U.S. Application Data
(63) Continuation of application No. PCT/JP2024/003960, filed on Feb. 6, 2024.

(30) Foreign Application Priority Data
Mar. 10, 2023 (JP) 2023-037432

(51) Int. Cl. H01M 50/242; H01M 10/613; H01M 10/625; H01M 10/647; H01M 10/658; H01M 50/209; H01M 50/249; H01M 50/293

(52) U.S. Cl. CPC H01M 50/242; H01M 10/613; H01M 10/625; H01M 10/647; H01M 10/658; H01M 50/209; H01M 50/249; H01M 50/293

(57) ABSTRACT

A stacked body (8) of a plurality of cells (80) for a secondary battery is accommodated in a cell-accommodating member (1). The cell-accommodating member (1) comprises: a housing (2) that has an interior space (20) in which the stacked body (8) is accommodated; inter-cell separators (3) that are arranged in the interior space (20) and are interposed between any pair of cells (80) that are adjacent to each other in the stacking direction, the inter-cell separators having electric insulation properties and thermal insulation properties; and elastic members (4) that are arranged at the inter-cell separators (3) and are in elastic contact with adjacent cells (80) in the stacking direction, the elastic members being more readily deformed in accordance with deformation of the cells (80) than the inter-cell separators (3).

### CROSS-REFERENCE TO RELATED APPLICATION

This application is a continuation of PCT International Application No. PCT/JP2024/003960, filed on Feb. 6, 2024, which claims priority under 35 U.S.C § 119 (a) to Japanese Patent Application No. 2023-037432, filed on Mar. 10, 2023. Each of the above application(s) is hereby expressly incorporated by reference, in its entirety, into the present application.

### TECHNICAL FIELD

The disclosure relates to a cell-accommodating member used in, for example, a vehicle-mounted battery module.

### RELATED ART

Patent Document 1 discloses a power supply device used as a drive source for a hybrid vehicle, an electric vehicle, etc. The power supply device includes a pair of end plates, a pair of fastening members, multiple secondary battery cells, and multiple separators. The pair of end plates and the pair of fastening members are combined to form a frame body in a rectangular shape. The secondary battery cells and the separators are accommodated inside the frame body. The secondary battery cells and the separators are alternately stacked. In other words, a separator made of a flexible member is interposed between a pair of secondary battery cells adjacent to each other in the stacking direction.

The separator possesses electrical insulation properties to ensure insulation between a pair of adjacent secondary battery cells and to suppress a short circuit. Additionally, the separator possesses thermal insulation properties to suppress heat transfer between the pair of secondary battery cells adjacent to each other and to suppress the chain reaction of thermal runaway. Furthermore, the separator has flexibility to absorb deformation (bulging and shrinkage) of the secondary battery cells. In this way, the separator possesses electrical insulation properties, thermal insulation properties, and flexibility.

### PRIOR ART DOCUMENT(S)

### Patent Document(s)

Patent Document 1: International Publication NO. 2018207608

However, in the case of the power supply device described in the same document, the electrical insulation properties and thermal insulation properties of the separator are prone to change in response to the deformation of the secondary battery cells. For example, when a secondary battery cell bulges, the separator adjacent to that secondary battery cell elastically shrinks accordingly. Through the shrinkage, the separator can absorb the bulging of the secondary battery cell. Nevertheless, when the separator shrinks, the distance between the pair of secondary battery cells adjacent to each other and sandwiching the separator becomes shorter accordingly.

Here, as mentioned earlier, the separator possesses not only flexibility but also electrical insulation properties and thermal insulation properties. Therefore, when the separator shrinks, the insulation distance and heat transfer distance between the pair of secondary battery cells adjacent to each other become shorter. Consequently, the electrical insulation properties and thermal insulation properties deteriorate. In this way, in the case of the power supply device described in the same document, the electrical insulation properties and thermal insulation properties of the separator are prone to change in response to the deformation of the secondary battery cells. Accordingly, the disclosure aims to provide a cell-accommodating member capable of stably ensuring the electrical insulation properties and thermal insulation properties of the inter-cell separator regardless of cell deformation.

### SUMMARY

A cell-accommodating member accommodates a stacked body of multiple cells for a secondary battery. With an extending direction of the stacked body being set as a stacking direction, the cell-accommodating member includes: a housing, having an interior space in which the stacked body is accommodated; an inter-cell separator, disposed in the interior space, interposed between an arbitrary pair of cells adjacent in the stacking direction, and possessing electrical and thermal insulation properties; and an elastic member, disposed on the inter-cell separator, elastically contacting the cell adjacent in the stacking direction, and being more elastically deformable following deformation of the cell than the inter-cell separator.

### BRIEF DESCRIPTION OF DRAWINGS

FIG. 1 is a perspective view of a vehicle-mounted battery module including a cell-accommodating member according to a first embodiment.

FIG. 2 is an exploded perspective view of the same vehicle-mounted battery module.

FIG. 3 is an exploded perspective view of the same cell-accommodating member.

FIG. 4 is an exploded perspective view of an inter-cell separator and an interlayer separator of the same cell-accommodating member.

FIG. 5 is a top view of the same vehicle-mounted battery module.

FIG. 6 is a cross-sectional view taken along a line VI-VI in FIG. 5.

FIG. 7 is a cross-sectional view taken along a line VII-VII in FIG. 5.

FIG. 8 is an enlarged view within a frame VIII in FIG. 7.

FIG. 9 is a cross-sectional view in the stacking direction of the cell-accommodating member according to the second embodiment.

### DESCRIPTION OF EMBODIMENTS

(1) To solve the above issue, a cell-accommodating member according to the disclosure accommodates a stacked body of multiple cells for a secondary battery. With an extending direction of the stacked body being set as a stacking direction, the cell-accommodating member includes: a housing, having an interior space in which the stacked body is accommodated; an inter-cell separator, disposed in the interior space, interposed between an arbitrary pair of cells adjacent in the stacking direction, and possessing electrical and thermal insulation properties; and an elastic member, disposed on the inter-cell separator, elastically contacting the cell adjacent in the stacking direction, and being more elastically deformable following deformation of the cell than the inter-cell separator.

With the cell-accommodating member according to the disclosure, the elastic member, which is a separate body from the inter-cell separator, is disposed on the inter-cell separator. The inter-cell separator has electrical and thermal insulation properties. Besides, the elastic member has the elasticity of being elastically deformable following the deformation of the cell. In this way, the inter-cell separator and the elastic member respectively share functions. In this way, even if the elastic member elastically deforms following the deformation of the cell 80, it is possible to suppress the deformation of the inter-cell separator 3. Therefore, even if the elastic member elastically deforms, it is possible to suppress changes in the thickness of the inter-cell separator in the stacking direction, that is, changes in the insulation distance and the heat transfer distance. In this way, according to the cell-accommodating member 1 of the disclosure, it is possible to stably ensure the electrical and thermal insulation properties of the inter-cell separator regardless of the deformation of the cell.
(2) In the above configuration, the cell may be a rectangular cell. In any of the above configurations, the cell-accommodating member may also be configured as being used in a vehicle-mounted battery module.
(3) In any of the above configurations, when viewed in the stacking direction, the elastic member is disposed on an inner side of the inter-cell separator. When the cell bulges in the stacking direction, the elastic member contracts in the stacking direction. Depending on the type of the elastic member, in accordance with the contraction, the elastic member may bulge outward (a direction intersecting with the stacking direction) when viewed from the stacking direction. According to the configuration, the elastic member is able to suppress the elastic member from bulging outward from the inter-cell separator.
(4) In any of the above configurations, a direction intersecting with the stacking direction may be set as a juxtaposition direction, multiple stacked bodies arranged along the juxtaposition direction may be accommodated in the interior space. In the configuration, the cell-accommodating member may further include an interlayer separator disposed in the interior space, interposed between an arbitrary pair of the stacked bodies that are adjacent to each other, and possessing electrical and thermal insulation properties. According to the configuration, it is possible to stably ensure electrical and thermal insulation properties between the arbitrary pair of stacked bodies.
(5) In any of the above configurations, the inter-cell separator may have an inter-cell separator side slit. In any of the above configurations (the configuration including the interlayer separator), the interlayer separator may also be configured as having an interlayer separator side slit.

In the configuration having the inter-cell separator has an inter-cell separator side slit, and the interlayer separator has an interlayer separator side slit, by fitting the inter-cell separator side slit and the interlayer separator side slit with each other, the inter-cell separator and the interlayer separator may be assembled in a crossed state. According to the configuration, it is possible to assemble the inter-cell separator and the interlayer separator simply and securely.

Additionally, it is possible to position the inter-cell separator and the interlayer separator simply and securely.
(6) In any of the above configurations, the housing may be configured as an integral component. According to the configuration, compared with the case where the housing is a composite article of multiple components (e.g., a pair of end plates, a pair of fastening members, in the power supply device of Patent Document 1), the number of parts can be reduced.

In the configuration, a direction intersecting with the stacking direction and the juxtaposition direction may be set as a cell insertion/removal direction, and the housing may have a tubular wall part, a bottom wall part, and an opening par., The tubular wall part extends in the cell insertion/removal direction, the bottom wall part seals an end of the tubular wall part in the cell insertion/removal direction, and the opening part is open on an other end of the tubular wall part in the cell insertion/removal direction. According to the configuration, the housing presents a bottomed tubular shape (bottomed box shape). For this reason, it is possible to easily insert and remove the cells, the inter-cell separators, and the elastic member, etc., into and from the interior space through the opening part.
(7) In any of the above configurations (a configuration including the tubular wall part), it may also be configured that the tubular wall part has a pair of first walls extending in the stacking direction and separately arranged at a predetermined interval along the juxtaposition direction, and an inner surface of the first wall is provided with a first guide groove into which at least an outer edge of the inter-cell separator, between the inter-cell separator and the elastic member, is inserted.

According to the configuration, it is possible to assemble the inter-cell separator to the first wall, that is, the housing, simply and securely. Additionally, it is possible to position the inter-cell separator with respect to the housing simply and securely.
(8) In any of the above configurations (a configuration including the tubular wall part, the interlayer separator), the tubular wall part may have a pair of second walls extending in the juxtaposition direction and separately arranged at a predetermined interval along the stacking direction, and, an inner surface of the second wall may be provided with a second guide groove into which an outer edge of the interlayer separator is inserted., According to the configuration, it is possible to assemble the interlayer separator to the second wall, that is, the housing, simply and securely. Additionally, it is possible to position the inter-cell separator with respect to the housing simply and securely.
(9) In any of the above configurations (a configuration including the bottom wall part), the cell-accommodating member may further include a cooling member disposed at the bottom wall part and cooling the cell. According to the configuration, it is possible to cool the cells.

According to the cell-accommodating member of the disclosure, it is possible to stably ensure the electrical and thermal insulation properties of the inter-cell separator regardless of the deformation of the cell.

The following describes embodiments of the cell-accommodating member of the disclosure. In the subsequent figures, the front-rear direction corresponds to the “stacking direction” of the disclosure, the left-right direction corresponds to the “juxtaposition direction” of the disclosure, and the upper-lower direction corresponds to the “cell insertion/removal direction” of the disclosure.

### First Embodiment

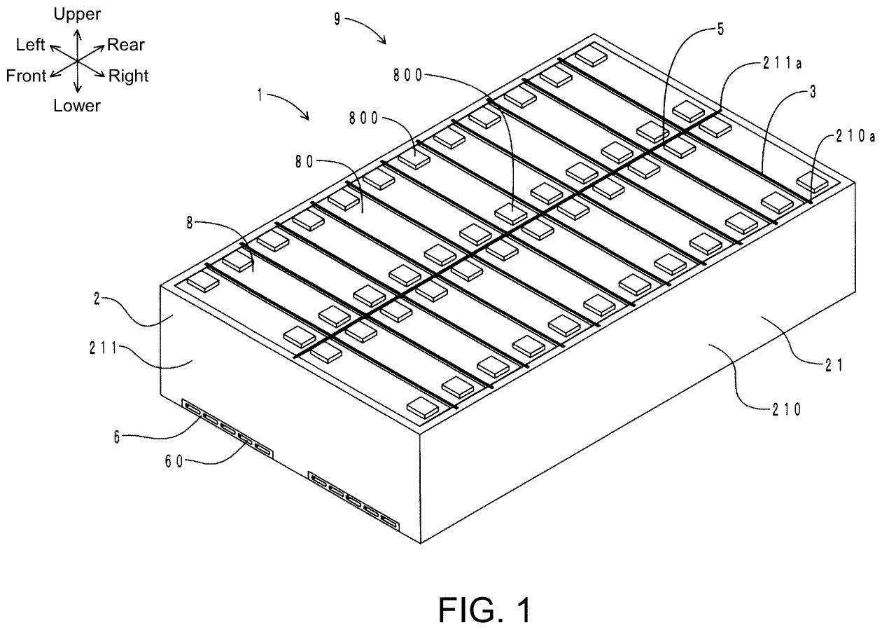

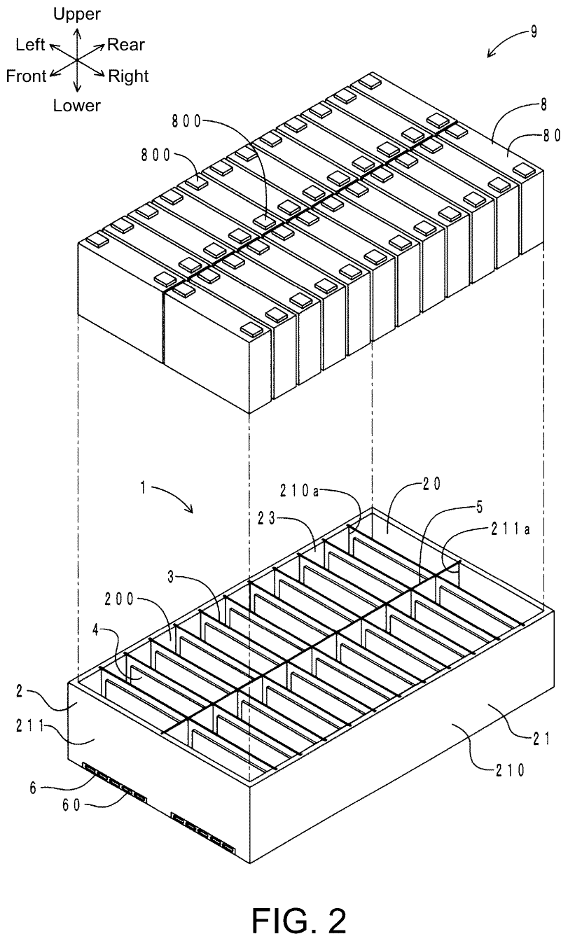

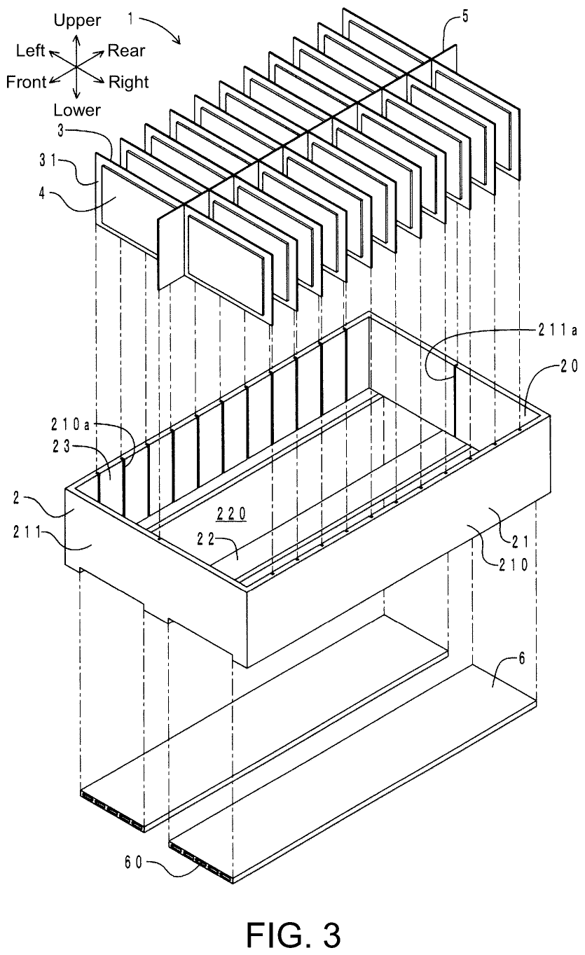

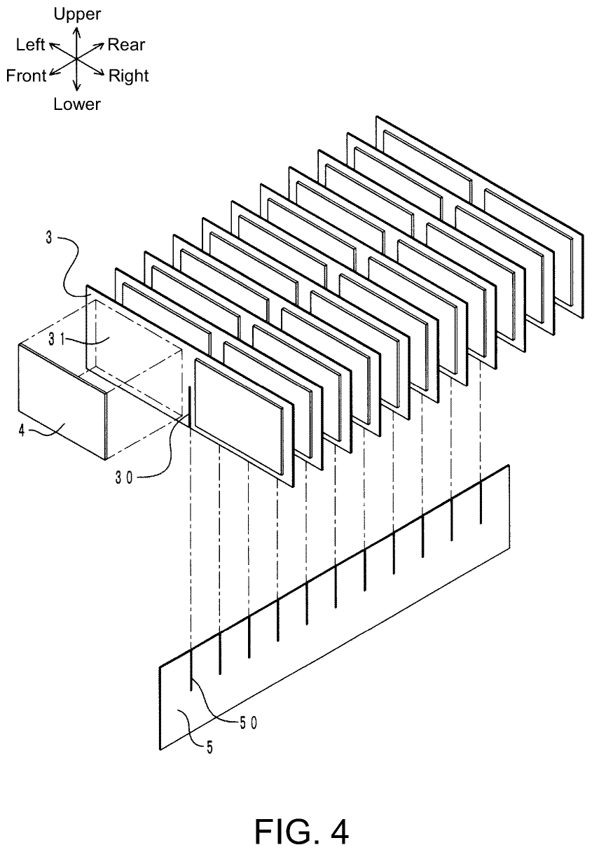

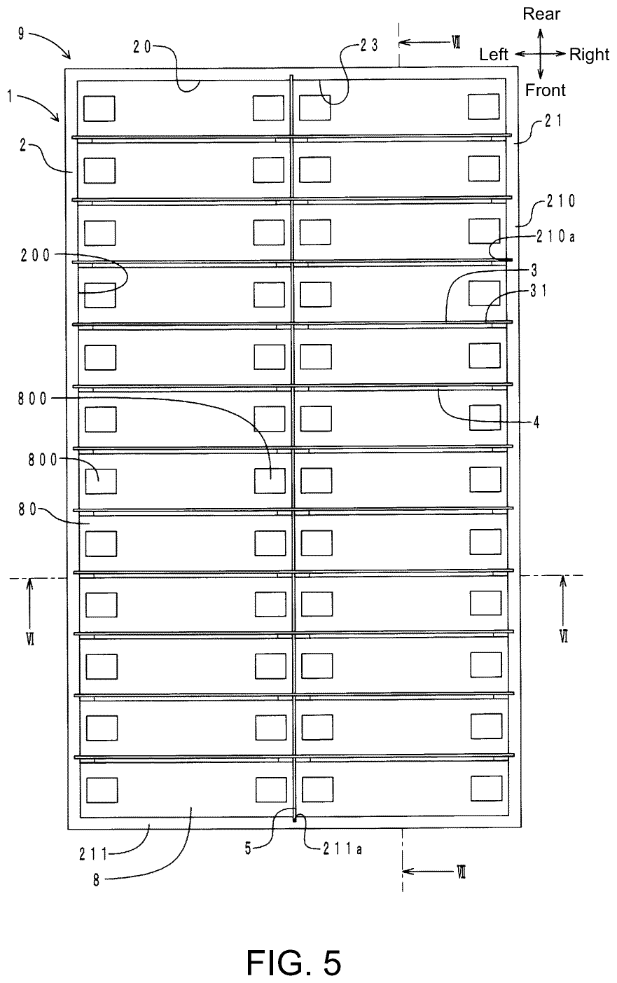

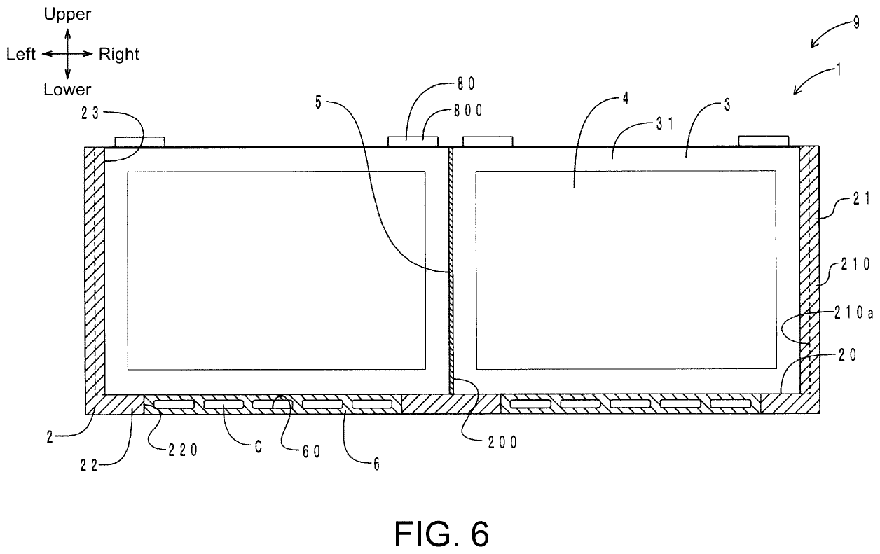

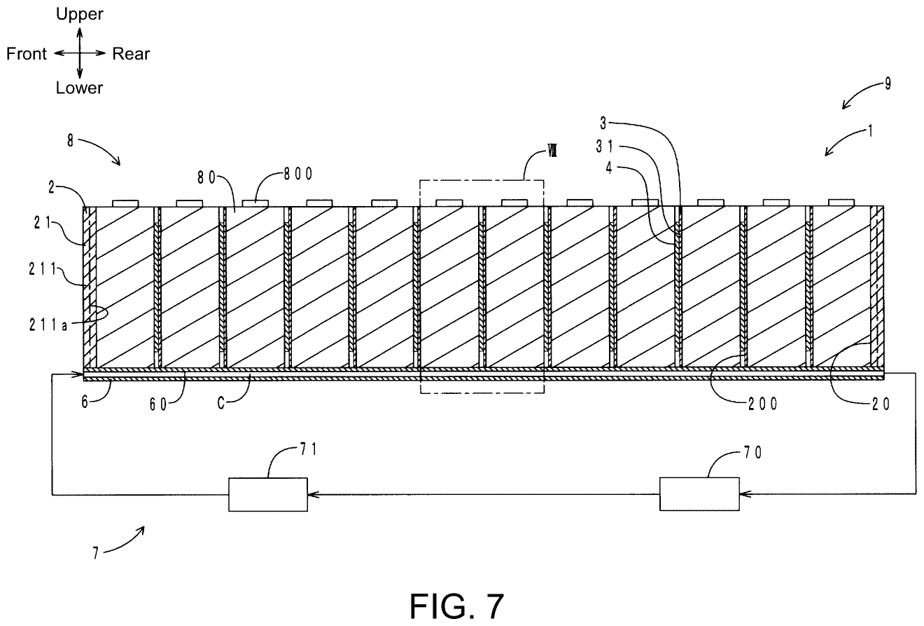

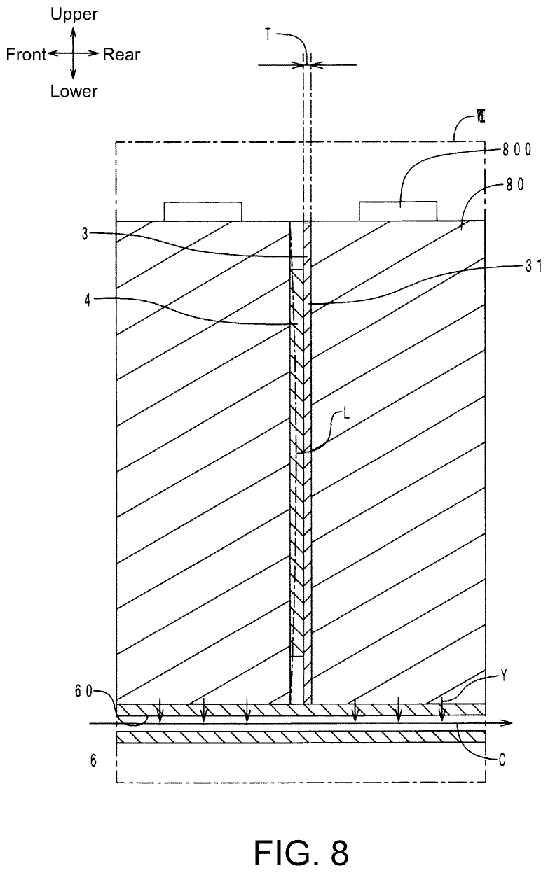

FIG. 1 is a perspective view illustrating a vehicle-mounted battery module including a cell-accommodating member according to the embodiment. FIG. 2 is an exploded perspective view illustrating the same vehicle-mounted battery module. FIG. 3 is an exploded perspective view of the same cell-accommodating member. FIG. 4 is an exploded perspective view illustrating an inter-cell separator and an interlayer separator of the same cell-accommodating member. FIG. 5 is a top view illustrating the same vehicle-mounted battery module. FIG. 6 is a cross-sectional view taken along a line VI-VI in FIG. 5. FIG. 7 is a cross-sectional view taken along a line VII-VII in FIG. 5. FIG. 8 is an enlarged view within a frame VIII in FIG. 7.

### Configuration of Cell-Accommodating Member

First, the configuration of the cell-accommodating member of the embodiment will be described. As shown in FIG. 1 and FIG. 2, a cell-accommodating member 1 of the embodiment is incorporated into a vehicle-mounted battery module 9. The cell-accommodating member 1 accommodates two stacked bodies 8.

### Stacked Body 8

The two stacked bodies 8 are arranged along the left-right direction. The stacked body 8 extends in the front-rear direction. As shown in FIG. 2 and FIG. 5, the stacked body 8 includes multiple cells 80 for a lithium-ion secondary battery. The cells 80 are stacked in the front-rear direction. When viewed from the upper side, the cell 80 presents a rectangular (flat) shape that is elongated in the left-right direction. In other words, the cell 80 is a rectangular cell. On the upper surface of the cell 80, terminals (positive electrode terminal, negative electrode terminal) 800 and a gas release valve (not shown) are arranged. The terminals 800 of adjacent cells 80 in the front-rear direction are electrically connected (serial connection, parallel connection) by a bus bar (not shown).

### Cell-Accommodating Member 1

The cell-accommodating member 1 includes a housing 2, multiple inter-cell separators 3, multiple elastic members 4, an interlayer separator 5, and two cooling members 6.

### Housing 2

As shown in FIG. 3, the housing 2 is an integral component made of resin. The housing 2 presents a bottomed tubular shape (rectangular box shape open on the upper side). The housing 2 includes an interior space 20, a tubular wall part 21, a bottom wall part 22, and an opening part 23. The interior space 20 is partitioned within the housing 2. The interior space 20 accommodates two stacked bodies 8.

The tubular wall part 21 presents an angular tubular shape extending in the upper-lower direction (with the tubular axis oriented in the upper-lower direction). When viewed from the upper side, the tubular wall part 21 presents a rectangular frame shape elongated in the front-rear direction. The tubular wall part 21 includes two first walls 210 and two second walls 211.

The two first walls 210 are arranged at a predetermined interval in the left-right direction. The first wall 210 presents a rectangular plate shape elongated in the front-rear direction. Multiple first guide grooves 210a are recessed on the inner surface of the first wall 210. The multiple first guide grooves 210a are juxtaposed along the front-rear direction. The first guide groove 210a extends in the upper-lower direction. The left and right edges (outer edges) of the inter-cell separator 3, which will be described later, are inserted into the first guide grooves 210a in pair in the left-right direction (specifically, first guide grooves 210a in pair at the same position in the front-rear direction among the first guide grooves 210a of the first wall 210 on the left side and the first guide grooves 210a of the first wall 210 on the right side).

The two second walls 211 are arranged at a predetermined interval in the front-rear direction. The second wall 211 presents a rectangular plate shape elongated in the left-right direction. A second guide groove 211a is recessed on the inner surface of the second wall 211 at the center in the left-right direction. The second guide groove 211a extends in the upper-lower direction. The front and rear edges (outer edges) of the interlayer separator 5, which will be described later, are inserted into the second guide grooves 211a in pair in the front-rear direction.

The bottom wall part 22 seals the lower end (an end in the cell insertion/removal direction) of the tubular wall part 21. The bottom wall part 22 presents a rectangular plate shape elongated in the front-rear direction. Two mounting ports 220 are formed to open in the bottom wall part 22. When viewed from the upper side, the two mounting ports 220 are arranged to be separated in the left-right direction by sandwiching the second guide groove 211a. The mounting port 220 penetrates the bottom wall part 22 in the upper-lower direction and the front-rear direction.

The opening part 23 is formed at the upper end (the other end in the cell insertion/removal direction) of the tubular wall part 21. The stacked body 8 (cell 80) to be described later, the inter-cell separator 3 with the elastic member 4, and the interlayer separator 5 are inserted into the interior space 20 through the opening part 23. Alternatively, the components are removed from the interior space 20.

### Inter-Cell Separator 3

As shown in FIG. 2 and FIG. 3, the inter-cell separators 3 are disposed in the interior space 20. As shown in FIG. 5, FIG. 7, and FIG. 8, the inter-cell separator 3 is interposed between a pair of cells 80 adjacent the front-rear direction in the stacked body 8. The inter-cell separator 3 is made of resin and presents a plate shape elongated in the left-right direction. The inter-cell separator 3 extends across the entire length of the interior space 20 in the left-right direction. The inter-cell separator 3 possesses electrical and thermal insulation properties. As shown in FIG. 4 and FIG. 6, the inter-cell separator 3 includes an inter-cell separator side slit 30 and inter-cell partition wall parts 31 in pair in the left-right direction.

The inter-cell separator side slit 30 is disposed between the inter-cell partition wall parts 31 in pair in the left-right direction (at the center in the left-right direction). The inter-cell separator side slit 30 opens at the lower edge of the inter-cell separator 3. The inter-cell separator side slit 30 extends to the center of the inter-cell separator 3 in the upper-lower direction.

### Elastic Member 4

As shown in FIG. 4, FIG. 6, FIG. 7, and FIG. 8, multiple elastic members 4 are each disposed on the front surface (single side) of the inter-cell partition wall part 31 of the inter-cell separator 3. The elastic member 4 is a separate component from the inter-cell separator 3 and is fixed to the inter-cell separator 3. When viewed from the front side, the elastic member 4 is disposed on the inner side (inner side in the left-right direction and the inner side in the upper-lower direction) of the inter-cell partition wall part 31. The elastic member 4 is made of foam rubber and presents a plate shape. The elastic member 4 has elasticity. The elastic member 4 elastically contacts the cell 80 on the front side thereof by using an elastic restoring force. In other words, in the state where the stacked body 8 is accommodated in the cell-accommodating member 1, a predetermined elastic energy is stored in the elastic member 4. The elastic member 4 is more flexible than the cell 80 and the inter-cell partition wall part 31. The elastic member 4 is more likely to elastically deform following the deformation of the cell 80 than the inter-cell separator 3 (inter-cell partition wall part 31).

### Interlayer Separator 5

As shown in FIG. 2 and FIG. 3, the interlayer separator 5 is disposed in the interior space 20. As shown in FIG. 5, the interlayer separator 5 is interposed between the pair of stacked bodies 8 in the left-right direction. The interlayer separator 5 is made of resin and presents a plate shape elongated in the front-rear direction. The interlayer separator 5 extends across the entire length of the interior space 20 in the front-rear direction. The interlayer separator 5 has electrical and thermal insulation properties. As shown in FIG. 4, the interlayer separator 5 includes multiple interlayer separator side slits 50. The multiple interlayer separator side slits 50 are juxtaposed in the front-rear direction by being separated at a predetermined interval. The interlayer separator side slit 50 opens on the upper edge of the interlayer separator 5. The interlayer separator side slit 50 extends until the center of the interlayer separator 5 in the upper-lower direction.

As shown in FIG. 3 and FIG. 4, the inter-cell separator 3 and the interlayer separator 5 are assembled in a crossed state by fitting (engaging) the inter-cell separator side slit 30 and the interlayer separator side slit 50 with each other in the upper-lower direction. As shown in FIG. 2 and FIG. 5, multiple cell chambers 200 arranged in the front-rear and left-right directions are partitioned in the interior space 20 by using the inter-cell separators 3 and the interlayer separator 5 assembled in a crossed state. An arbitrary cell chamber 200 is isolated from the cell chamber 200 adjacent in the front-rear direction and the cell chamber 200 adjacent in the left-right direction. Each of the multiple cell chambers 200 accommodates a cell 80.

### Cooling Member 6

As shown in FIG. 3, two cooling members 6 are each disposed at the mounting port 220 of the bottom wall part 22. The cooling member 6 is made of resin and presents a rectangular plate shape elongated in the front-rear direction. As shown in FIG. 6, FIG. 7, and FIG. 8, the upper surface of the cooling member 6 is in contact with the lower surface of the cell 80. Multiple flow paths 60 are formed inside the cooling member 6. The flow paths 60 are arranged in the left-right direction. The flow path 60 penetrates the cooling member 6 in the front-rear direction. A coolant C flows through the flow path 60. The cooling member 6 cools the cell 80 by using the coolant C. As shown in FIG. 7, the flow path 60 is connected to the cooling circuit 7 outside the vehicle-mounted battery module 9. The cooling circuit 7 includes a radiator 70 and a pump 71. The coolant C that flows out from the flow path 60 is cooled by the radiator 70. The coolant C that flows out from the radiator 70 is pressurized by the pump 71 and flows into the flow path 60.

### Assembling Method of Cell-Accommodating Member

Next, an assembling method of the cell-accommodating member in the embodiment will be described. As shown in FIG. 3, the cooling member 6 is fixed in advance to the mounting port 220 of the bottom wall part 22 of the housing 2. Additionally, the elastic member 4 is fixed in advance to the inter-cell separator 3.

First, the interlayer separator 5 is inserted into the interior space 20 of the housing 2. Specifically, the front and rear edges of the interlayer separator 5 are each inserted into the second guide groove 211a. Next, the inter-cell separators 3 are inserted into the interior space 20 of the housing 2. Specifically, the left and right edges of the inter-cell separator 3 are each inserted into the first guide groove 210a. In addition, the inter-cell separator side slit 30 and the interlayer separator side slit 50 are fit with each other. In this way, the cell-accommodating member 1 is assembled. Subsequently, as shown in FIG. 2, multiple cells 80 are each inserted into the cell chamber 200.

### Functions & Effects

Next, the functions and effects of the cell-accommodating member in the embodiment will be described. As shown in FIG. 8, the elastic member 4, which is a separate component from the inter-cell separator 3, is disposed on the inter-cell separator 3. The inter-cell separator 3 has electrical and thermal insulation properties. On the other hand, the elastic member 4 is more flexible than the cell 80 and the inter-cell separator 3. Additionally, the elastic member 4 has the elasticity of being deformable following the deformation of the cell 80. In this way, the inter-cell separator 3 and the elastic member 4 respectively share functions.

For example, as indicated by a dot-chain line L in FIG. 8, the cell 80 may bulge in the front-rear direction due to charging or deterioration. In such case, it is possible for the elastic member 4 to shrink in the front-rear direction by the amount of the bulging of the cell 80. Through the shrinkage, the elastic member 4 can absorb the bulging of the cell 80. Furthermore, since the bulging of the cell 80 is absorbed by the elastic member 4, even if the cell 80 bulges, a thickness T of the inter-cell separator 3 in the front-rear direction (inter-cell partition wall part 31) remains unchanged. As a result, it is possible to suppress the shortening of the insulation distance and the heat transfer distance.

Comparatively, in the case where the cell 80 shrinks in the front-rear direction, the elastic member 4 can bulge in the front-rear direction by the amount of shrinkage of the cell 80 by using the elastic restoring force of its own. Through the bulging, the elastic member 4 can absorb the shrinkage of the cell 80. Furthermore, since the shrinkage of the cell 80 is absorbed by the elastic member 4, even if the cell 80 shrinks, the thickness T of the inter-cell separator 3 (inter-cell partition wall part 31) in the front-rear direction remains unchanged. As a result, it is possible to suppress the increase of the insulation distance and the heat transfer distance.

In this way, according to the cell-accommodating member 1 of the embodiment, even if the elastic member 4 elastically deforms following the deformation of the cell 80, it is possible to suppress the deformation of the inter-cell separator 3. Therefore, even if the elastic member 4 elastically deforms, it is possible to suppress changes in the thickness T of the inter-cell separator 3 in the front-rear direction, that is, changes in the insulation distance and the heat transfer distance. Thus, according to the cell-accommodating member 1 of the embodiment, it is possible to stably ensure the electrical and thermal insulation properties of the inter-cell separator 3 regardless of the deformation of the cell 80.

The elastic member 4 is made of foam rubber. For this reason, compared to the case where the elastic member 4 is made of fiber (for example, knitted fabric, woven fabric, etc. However, even such case is included in the concept of “elastic member” of the disclosure.), it is less likely to undergo plastic deformation and viscous deformation, and has a greater elastic restoring force. Therefore, the restraining force in the front-rear direction with respect to the stacked body 8 is less likely to decrease.

The elastic member 4 is capable of deforming in response to the deformation of the outer surface of the cell 80. For this reason, even if only a portion of the cell 80 bulges, the elastic member 4 can absorb such deformation. Therefore, it is less likely for a local load to be applied to the inter-cell separator 3 or the cell 80.

As shown in FIG. 1 and FIG. 2, two stacked bodies 8 arranged along the left-right direction are accommodated in the interior space 20. Additionally, the interlayer separator 5 having electrical and thermal insulation properties is disposed between the two stacked bodies 8. As a result, it is possible to ensure electrical and thermal insulation properties between the two adjacent stacked bodies 8.

As shown in FIG. 1 and FIG. 2, the cell 80 is a rectangular cell. Additionally, the interior space 20 presents a rectangular parallelepiped shape. Therefore, it is possible to densely arrange multiple cells 80 within the interior space 20. Therefore, the space efficiency increases.

As shown in FIG. 4, the inter-cell separator 3 includes an inter-cell separator side slit 30. The interlayer separator 5 includes the interlayer separator side slit 50. The inter-cell separator 3 and the interlayer separator 5 are assembled in a crossed state by fitting the inter-cell separator side slit 30 and the interlayer separator side slit 50 with each other. For this reason, it is possible to assemble the inter-cell separator 3 and the interlayer separator 5 simply and securely. Additionally, it is possible to position the inter-cell separator 3 and the interlayer separator 5 simply and securely. Furthermore, as shown in FIG. 4, the upper end bottom of the inter-cell separator side slit 30 and the lower end bottom of the interlayer separator side slit 50 are in contact with each other. For this reason, it is possible to gaplessly assemble the inter-cell separator 3 and the interlayer separator 5. Moreover, since there is no gap between the inter-cell separator 3 and the interlayer separator 5, it is possible to suppress heat transfer between cells 80 through gaps.

As shown in FIG. 6, the left and right edges of the inter-cell separator 3 are inserted into the first guide grooves 210a in pair in the left-right direction. For this reason, it is possible to assemble the inter-cell separator 3 to the first wall 210, that is, the housing 2, simply and securely. Additionally, it is possible to position the inter-cell separator 3 with respect to the housing 2 simply and securely. Moreover, since there is no gap between the first guide groove 210a and the inter-cell separator 3, it is possible to suppress heat transfer between the cells 80 through gaps.

As shown in FIG. 5, the front and rear edges of the interlayer separator 5 are inserted into the second guide grooves 211a in pair in the front-rear direction. For this reason, it is possible to assemble the interlayer separator 5 to the second wall 211, that is, the housing 2, simply and securely. Additionally, it is possible to position the interlayer separator 5 with respect to the housing 2 simply and securely. Moreover, since there is no gap between the second guide groove 211a and the interlayer separator 5, it is possible to suppress heat transfer between cells 80 through gaps.

The inter-cell separator 3 is securely fixed by using the housing 2 (first guide groove 210a) and the interlayer separator 5 (interlayer separator side slit 50). For this reason, the rigidity of the inter-cell separator 3 is high. Additionally, the interlayer separator 5 is securely fixed by the housing 2 (second guide groove 211a) and the inter-cell separator 3 (inter-cell separator side slit 30). For this reason, the rigidity of the interlayer separator 5 is high. Moreover, the housing 2 is supported from the side of the interior space 20 by the inter-cell separator 3 and the interlayer separator 5 assembled in a crossed state. For this reason, the rigidity of the housing 2 is high. Furthermore, the cell chambers 200 are isolated from each other by the inter-cell separators 3 and the interlayer separator 5 assembled in a crossed state. For this reason, it is possible to suppress heat transfer between the cells 80.

When the cell 80 bulges in the front-rear direction, the elastic member 4 contracts in the stacking direction. In response to the shrinkage, the elastic member 4, when viewed from the front side, bulges outward (in the upper-lower and left-right directions in FIG. 6). In this regard, when viewed from the front side, the elastic member 4 is disposed on the inner side of the inter-cell separator 3. For this reason, it is possible to suppress the elastic member 4 from bulging outward from the inter-cell separator 3.

The inter-cell separator 3 has electrical and thermal insulation properties. For this reason, compared to the case where a separator for electrical insulation and a separator for thermal insulation are disposed independently, it is possible to reduce the number of parts of the cell-accommodating member 1. Additionally, it is possible to save the space of the cell-accommodating member 1. Moreover, since the inter-cell separator 3 has electrical insulation properties, the exterior material (case) of the cell 80 does not need to possess electrical insulation properties.

The inter-cell separator 3 has a function of partitioning the cell chambers 200 in addition to possessing electrical and thermal insulation properties. In other words, the inter-cell separator 3 has a function of positioning the cells 80. For this reason, compared to the case where a component for positioning the cells 80 is disposed separately in addition to the inter-cell separator 3, it is possible to reduce the number of parts of the cell-accommodating member 1. Additionally, it is possible to save the space of the cell-accommodating member 1.

As shown in FIG. 3, the housing 2 is an integral component. For this reason, compared to the case where the housing 2 is a composite of multiple components, it is possible to reduce the number of parts. The housing 2 presents a bottomed tubular (bottomed box) shape. For this reason, it is possible to easily insert and remove the cells 80, the inter-cell separators 3 with elastic members 4, and the interlayer separator 5 into and from the interior space 20 through the opening part 23.

As indicated in FIG. 6, FIG. 7, and FIG. 8, two cooling members 6 are disposed on the bottom wall part 22. As indicated by arrow signs Y in FIG. 8, the heat from the cells 80 is transferred to the coolant C through the wall parts of the cooling members 6. For this reason, it is possible to cool the cells 80. Additionally, the cooling members 6 and the cells 80 are in direct contact without any other components intervening. For this reason, it is possible to effectively cool the cells 80. Moreover, the inter-cell separators 3 and the interlayer separator 5 are disposed on the peripheries of the cells 80. Both the inter-cell separator 3 and the interlayer separator 5 have thermal insulation properties. For this reason, it is possible to preferentially guide the heat of the cell 80 to the cooling member 6. It should be noted that an elastic body with high heat conductivity may be interposed between the cooling member 6 and the cell 80. In this case, for example, it is desirable that the thermal conductivity of the elastic body at 25° C. is 3 W/(m·K) or higher.

As indicated in FIG. 3, the cell-accommodating member 1 of the embodiment can be assembled by simply inserting the interlayer separator 5 and the inter-cell separators 3 with the elastic members 4 into the housing 2. For this reason, the assembling operation of the cell-accommodating member 1 is simple. Additionally, the vehicle-mounted battery module 9 can be assembled by simply inserting the cells 80 into the cell chambers 200 of the assembled cell-accommodating member 1. For this reason, the assembling operation of the vehicle-mounted battery module 9 is simple.

### Second Embodiment

The difference between the cell-accommodating member of this embodiment and that of the first embodiment is that elastic members are disposed on both sides in the front-rear direction of the inter-cell separators. Here, only the difference will be described.

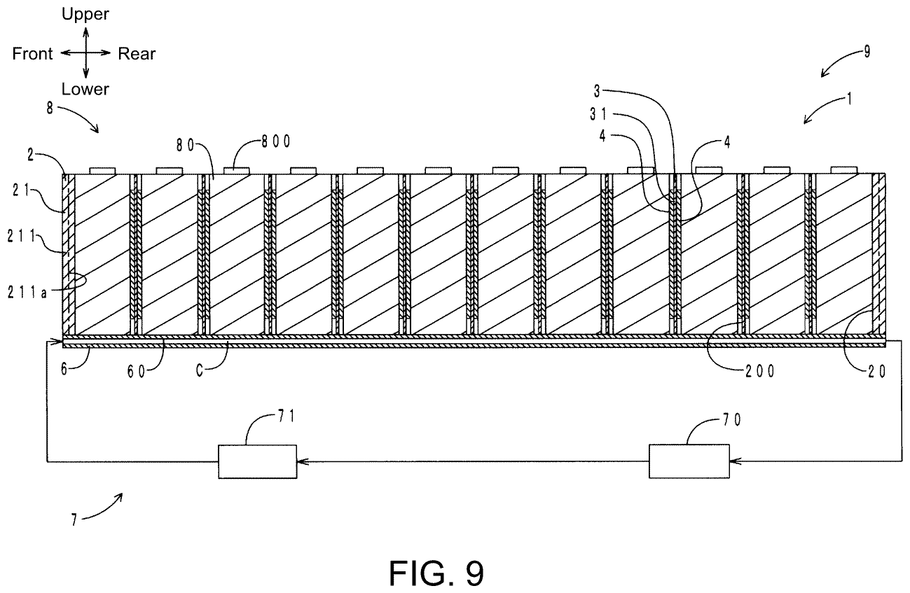

FIG. 9 is a cross-sectional view in the stacking direction (front-rear direction) of the cell-accommodating member of the embodiment. It should be noted that parts corresponding to FIG. 7 are indicated by the same reference numerals. As indicated in FIG. 9, the elastic members 4 are disposed on both sides in the front-rear direction of the inter-cell separator 3 (inter-cell partition wall part 31). The cell-accommodating member of the embodiment and the cell-accommodating member of the first embodiment have the same functional effects with respect to the portions having common configurations. According to the cell-accommodating member 1 of the embodiment, both sides of the cells 80 in the front-rear direction (except for the cells 80 at both ends of the stacked body 8 in the front-rear direction) are elastically in contact with the elastic members 4. For this reason, it is possible to absorb the deformation on both sides of the cells 80 in the front-rear direction.

### Others

The above describes embodiments of the cell-accommodating member of the disclosure. However, the embodiments are not particularly limited to the above-described forms. It is possible for those skilled in the art to implement various modifications and improvements.

### Regarding Arrangements and Configurations

In the embodiments, the stacking direction (front-rear direction), the juxtaposition direction (left-right direction), and the cell insertion/removal direction (upper-lower direction) are set to be mutually perpendicular. However, the intersection angles of these directions are not particularly limited. Additionally, the orientations of the stacking direction, the juxtaposition direction, and the cell insertion/removal direction are not particularly limited. For example, the stacking direction may be in the upper-lower direction. The stacking direction may also be set as the direction in which the cells 80 experience the greatest deformation. In the case where the cells 80 are rectangular cells or laminate cells, the stacking direction may also be aligned with the stacking direction of the positive electrode layers, the separators, and the negative electrode layers inside the cells 80.

The quantity of the inter-cell separators 3 that are arranged is not particularly limited. The quantity of the inter-cell separators 3 that are arranged may be single or plural. The quantity of the inter-cell separators 3 that are arranged may be increased or decreased according to the number of cells 80 constituting the stacked body 8. The quantity of the inter-cell partition wall parts 31 that are arranged in the inter-cell separator 3 is not particularly limited. The quantity of the inter-cell partition wall parts 31 that are arranged may be single or plural. The quantity of the inter-cell partition wall parts 31 that are arranged may be increased or decreased according to the quantity of cells 80 that are arranged along the juxtaposition direction (i.e., the quantity of the stacked bodies 8 that are arranged). The quantity of the interlayer separators 5 that are arranged is not particularly limited. The quantity of the interlayer separators 5 that are arranged may be single or plural. The quantity of the interlayer separators 5 that are arranged may be increased or decreased according to the quantity of the stacked bodies 8 that are arranged.

The orientations of the inter-cell separator side slits 30 and the interlayer separator side slits 50 are not particularly limited. It is sufficient that the inter-cell separator side slits 30 and the interlayer separator side slits 50 face each other in the cell insertion/removal direction so that the inter-cell separator side slits 30 and the interlayer separator side slits 50 can be mutually fit. For example, the interlayer separator side slits 50 may face an end side (lower side) in the cell insertion/removal direction, while the inter-cell separator side slits 30 may face the other end side (upper side) in the cell insertion/removal direction. In this case, at the time of assembling the cell-accommodating member 1, it may also be that the inter-cell separators 3 are firstly inserted, and then the interlayer separators 5 are inserted into the interior space 20. Of course, regardless of the orientations of the inter-cell separator side slits 30 and the interlayer separator side slits 50, it is also possible to assemble the inter-cell separators 3 and the interlayer separators 5 outside the housing 2, and then insert the assembled unit into the interior space 20.

The assembling method for the inter-cell separators 3 and the interlayer separators 5 is not particularly limited. The inter-cell separators 3 and the interlayer separators 5 may also be assembled by using fasteners (bolts, screws, clips, etc.) The inter-cell separators 3 and the interlayer separators 5 may also be assembled by adhesion (adhesives, double-sided tape, etc.), pressure-bonding, or welding. An integral grid-shaped separator in which the inter-cell separators 3 and the interlayer separators 5 are integrally formed may also be used. The housing 2 may be integrated with at least one of the inter-cell separators 3 and the interlayer separators 5.

The quantity of the elastic members 4 arranged with respect to the inter-cell separators 3 is not particularly limited. It is sufficient that the elastic members 4 are disposed on at least one side of both sides of the inter-cell separators 3 in the stacking direction. The types of the inter-cell separators 3 are not particularly limited. It is sufficient that at least one of the inter-cell separators 3 is an inter-cell separator 3 with the elastic member 4. The size of the elastic member 4 with respect to the inter-cell separator 3 is not particularly limited. For example, the elastic members 4 may be disposed on the entirety of at least one side of both sides in the stacking direction of the inter-cell separators 3. The method of fixing the elastic members 4 to the inter-cell separators 3 is not particularly limited. The elastic members 4 may be fixed to the inter-cell separators 3 by adhesion (adhesives, double-sided tape, etc.), pressure bonding, or welding. The elastic members 4 may be disposed on the inner surface of the second walls 211 and elastically contact the cells 80 at both ends of the stacked body 8 in the stacking direction. The elastic members 4 may be disposed on the interlayer separators 5.

At the time of inserting the left and right edges of the inter-cell separators 3 into the first guide grooves 210a, the left and right edges of the elastic members 4 may also be inserted into the first guide grooves 210a. In this case, the elastic members 4 are compressed between the groove side surfaces of the first guide grooves 210a and the inter-cell separators 3. As a result, the inter-cell separators 3 become less likely to fall out of the first guide grooves 210a. In this manner, it is sufficient that at least the inter-cell separators 3, among the inter-cell separators 3 and the elastic members 4, are inserted into the first guide grooves 210a.

The shape of the tubular wall part 21 of the housing 2 is not particularly limited. It may be angular tubular (rectangular tubular, hexagonal tubular, octagonal tubular, etc.), cylindrical (circular cylindrical, elliptical cylindrical, etc.), or the like. When viewed from the cell insertion/removal direction, the tubular wall part may be in an endless annular shape. The shape of the bottom wall part 22 is not particularly limited. It is sufficient if the bottom wall part 22 can seal an end of the tubular wall part 21 in the cell insertion/removal direction. The bottom wall part 22 may also be omitted. In this case, it is sufficient to seal an end of the tubular wall part 21 in the cell insertion/removal direction by using the cooling member 6. Also, the cells 80 do not have to be disposed in all of the cell chambers 200.

The quantity of the cooling members 6 that are arranged is not limited. The quantity of the cooling members 6 that are arranged and the quantity of the stacked bodies 8 that are arranged may be the same or different. For example, it may also be that one single cooling member 6 is disposed for two stacked bodies 8. The quantity of the flow paths 60 that are arranged is not limited. The type of coolant is not limited. For example, in the case where the cell-accommodating member 1 is used in the vehicle-mounted battery module 9, the coolant may be a vehicle coolant. The type of the cooling member 6 is not particularly limited. The cooling member 6 may include a heat pipe or a fan. It may also be that the cooling member 6 does not include the flow path 60.

The type of cells 80 is not particularly limited. The cell may be a rectangular cell, a cylindrical cell, a laminate-type cell, or the like. The type of the secondary battery is not particularly limited. The secondary battery may be a lithium-ion secondary battery, a lithium-ion polymer secondary battery, a sodium-ion secondary battery, a nickel-hydrogen secondary battery, or the like.

The purposes of the cell-accommodating member 1, that is, the battery module, are not particularly limited. For example, the cell-accommodating member 1 may be used in a hybrid vehicle, an electric vehicle, or the like. Additionally, the cell-accommodating member 1 may also be used in an electrically assisted bicycle, a mobile phone, a power tool, a laptop computer, or the like.

### Regarding Materials

The material of the cooling member 6 is not particularly limited. For example, the material may be a resin such as polypropylene (PP), or a metal such as aluminum or aluminum alloy.

The material of the elastic member 4 is not particularly limited. For example, the material of the elastic member 4 may be a foam of an elastomer (including rubber), such as ethylene propylene diene monomer (EPDM), silicone, butyl rubber, acrylic rubber, or the like. The form of the elastic member 4 is not particularly limited. It may be a foam, woven fabric, non-woven fabric, hollow body, solid body, or the like.

The material of the housing 2 is not particularly limited. For example, the material may be a resin such as PP, or a metal such as steel, aluminum or aluminum alloy. The material of the inter-cell separator 3 and the interlayer separator 5 is not particularly limited. For example, the material may be a resin such as epoxy, ceramics, or the like.

The insulation properties of the inter-cell separator 3 are not particularly limited. It is sufficient if electrical insulation between the adjacent cells 80 sandwiching the inter-cell separator 3 can be ensured. For example, it is desirable that the electrical resistivity at 25° C. is 10E+10 Ω·m or more. The same applies to the interlayer separator 5.

The thermal insulation properties of the inter-cell separator 3 are not particularly limited. It is sufficient if thermal insulation between the adjacent cells 80 sandwiching the inter-cell separator 3 can be ensured. For example, it is desirable that the thermal conductivity at 25° C. is 0.1 W/(m·K) or less. The same applies to the interlayer separator 5.

At least one of the housing 2, the inter-cell separator 3, and the interlayer separator 5 may use a fire-resistant insulating member as described below. The fire-resistant insulating member includes cellulose fibers, inorganic fibers, flame-retardant inorganic particles, fire-resistant inorganic particles, and a binder resin.

Cellulose fibers are fibers made from cellulose as a raw material. Examples of cellulose fibers include plant fibers such as cotton and hemp, regenerated fibers such as rayon and Lyocell (registered trademark), and semi-synthetic fibers such as acetate.

The inorganic fibers are preferably one or more selected from glass fibers, alumina fibers, and silica fibers, considering electrical insulation properties and flame retardancy. From the viewpoint of enhancing the strength and fire resistance of the fire-resistant thermal insulating member, it is desirable for the inorganic fibers to be relatively thick and long. For example, the fiber diameter of the inorganic fibers is preferably 1 μm or more and 20 μm or less. In addition, the length of the inorganic fibers is preferably 13 mm or more and 25 mm or less. In the case where the length is less than 13 mm, the effect of improving strength may be small, and in the case where the length is greater than 25 mm, there is a risk that moldability may decrease.

Considering the balance between the retention capacity and flame retardancy of inorganic particles, it is desirable that the content mass of cellulose fibers is equal to or less than the content mass of inorganic fibers. In other words, it is desirable that the content mass of cellulose fibers is the same as or less than the content mass of inorganic fibers.

The flame-retardant inorganic particles suppress the combustion by decomposing themselves when heated. Examples of flame-retardant inorganic particles include particles of metal hydroxides and inorganic phosphorus-based flame retardants known as inorganic flame retardants. Examples of metal hydroxides include aluminum hydroxide and magnesium hydroxide, etc. Examples of inorganic phosphorus-based flame retardants include ammonium polyphosphate. Among these, inorganic phosphorus-based flame retardants are particularly suitable because they form a non-combustible layer consisting of a carbonized film when heated, resulting in a high combustion suppression effect.

The fire-resistant inorganic particles contribute to improving the fire resistance of the fire-resistant insulating member because such particles are difficult to burn when heated. Examples of fire-resistant inorganic particles include particles of inorganic materials classified as “non-combustible materials” that meet three requirements, such as not burning for 20 minutes from the start of heating, according to the Building Standards Act. For example, talc, mica, kaolinite, silica, alumina, and the like may be used.

The binder resin is not particularly limited in type as long as it can bond the fiber materials (including cellulose fibers and inorganic fibers) to each other and the fiber materials to the inorganic particles. The binder resin may be either a thermoplastic resin or a thermosetting resin. In the case of using a thermoplastic resin, if the melting point is 200° C. or lower, such thermoplastic resin has the advantage of being able to melt at a relatively low temperature and easy to manufacture. When a thermosetting resin is used, the effect of enhancing the strength of the fire-resistant insulating member is significant. Examples of thermoplastic resins include polyvinyl alcohol, nylon resin, and fluorine resin. Examples of thermosetting resins include phenolic resin, epoxy resin, unsaturated polyester resin, and vinyl ester resin.

It is desirable that the content mass of organic materials (including cellulose fibers and binder resin) is 5 times or less than the content mass of flame-retardant inorganic particles. By doing so, it is possible to achieve the desired flame retardancy and heat insulation properties while ensuring the particle retention capacity of cellulose fibers and the bonding strength of the binder resin. From the viewpoint of enhancing the retention capacity of inorganic particles and the bonding strength between inorganic particles and fiber materials, as well as between fiber materials, it is desirable that the content mass of organic materials is 40 mass % or more when the entire fire-resistant insulating member is taken as 100 mass %. It is more preferable if the content mass of organic materials is 50 mass % or more.

From the viewpoint of forming a dense skeleton by using fiber materials, enhancing the retention capacity of inorganic particles, and ultimately improving the strength of the fire-resistant insulating member, it is desirable that the total content mass of flame-retardant inorganic particles, fire-resistant inorganic particles, and binder resin is ⅔ or less of the total content mass of cellulose fibers and inorganic fibers. Here, “⅔ or less” means that when the total content mass of flame-retardant inorganic particles, fire-resistant inorganic particles, and binder resin is divided by the total content mass of cellulose fibers and inorganic fibers, the result is 0.67 or less. In the case where the division does not result in a whole number, the value after division should be rounded to the second decimal place and be 0.67 or less.

The thickness of the fire-resistant insulating member (for example, the wall thickness of the first wall 210 of the housing 2, the wall thickness of the second wall 211, the plate thickness of the inter-cell separator 3, the plate thickness of the interlayer separator 5) is not particularly limited, but from the viewpoint of the cell 80 accommodation capacity in the interior space 20, it is desirable for the thickness of the fire-resistant insulating member to be 5 mm or less. On the other hand, considering the fire resistance and heat insulation properties of the fire-resistant insulating member, it is desirable that the thickness is 1 mm or more. In addition, the fire-resistant insulating member may include other components in addition to cellulose fibers, inorganic fibers, flame-retardant inorganic particles, fire-resistant inorganic particles, and binder resin.

The fire-resistant insulating member can be manufactured by adopting a pulp molding method. The pulp molding method includes a dispersion liquid preparation process, an intermediate molded body formation process, and a drying process. In the dispersion liquid preparation process, a dispersion liquid is prepared by dispersing cellulose fibers, inorganic fibers, flame-retardant inorganic particles, fire-resistant inorganic particles, and binder resin in water. In the intermediate molded body formation process, a mold is immersed in the prepared dispersion liquid, and the dispersion liquid is sucked through the mold to form an intermediate molded body on the surface of the mold. In the drying process, a molded body is produced by heating and drying the formed intermediate molded body.

The fire-resistant insulating member can also be manufactured by adopting a compression molding method. The compression molding method includes a slurry preparation process and a compression molding process. In the slurry preparation process, a slurry is prepared by mixing cellulose fibers, inorganic fibers, flame-retardant inorganic particles, fire-resistant inorganic particles, and binder resin with water. In the compression molding process, a molded body is produced by accommodating the slurry in a mold and performing compression molding under heat.

What is claimed is:

1. A cell-accommodating member, accommodating a stacked body of a plurality of cells for a secondary battery,
with an extending direction of the stacked body being set as a stacking direction, the cell-accommodating member comprising:
a housing, having an interior space in which the stacked body is accommodated;
an inter-cell separator, disposed in the interior space, interposed between an arbitrary pair of cells adjacent in the stacking direction, and possessing electrical and thermal insulation properties; and
an elastic member, disposed on the inter-cell separator, elastically contacting the cell adjacent in the stacking direction, and being more elastically deformable following deformation of the cell than the inter-cell separator.

2. The cell-accommodating member as claimed in claim 1, wherein the cell is a rectangular cell, and
the cell is used in a vehicle-mounted battery module.

3. The cell-accommodating member as claimed in claim 1, wherein, when viewed in the stacking direction, the elastic member is disposed on an inner side of the inter-cell separator.

4. The cell-accommodating member as claimed in claim 1, wherein a direction intersecting with the stacking direction is set as a juxtaposition direction,
a plurality of the stacked bodies arranged along the juxtaposition direction are accommodated in the interior space, and
the cell-accommodating member further comprises an interlayer separator disposed in the interior space, interposed between an arbitrary pair of the stacked bodies that are adjacent to each other, and possessing electrical and thermal insulation properties.

5. The cell-accommodating member as claimed in claim 4, wherein the inter-cell separator has an inter-cell separator side slit,
the interlayer separator has an interlayer separator side slit, and
by fitting the inter-cell separator side slit and the interlayer separator side slit with each other, the inter-cell separator and the interlayer separator are assembled in a crossed state.

6. The cell-accommodating member as claimed in claim 4, wherein a direction intersecting with the stacking direction and the juxtaposition direction is set as a cell insertion/removal direction, and
the housing is an integral component and has a tubular wall part, a bottom wall part, and an opening part, wherein the tubular wall part extends in the cell insertion/removal direction, the bottom wall part seals an end of the tubular wall part in the cell insertion/removal direction, and the opening part is open on an other end of the tubular wall part in the cell insertion/removal direction.

7. The cell-accommodating member as claimed in claim 6, wherein the tubular wall part has a pair of first walls extending in the stacking direction and separately arranged at a predetermined interval along the juxtaposition direction, and
an inner surface of the first wall is provided with a first guide groove into which at least an outer edge of the inter-cell separator, between the inter-cell separator and the elastic member, is inserted.

8. The cell-accommodating member as claimed in claim 6, wherein the tubular wall part has a pair of second walls extending in the juxtaposition direction and separately arranged at a predetermined interval along the stacking direction, and
an inner surface of the second wall is provided with a second guide groove into which an outer edge of the interlayer separator is inserted.

9. The cell-accommodating member as claimed in claim 6, further comprising a cooling member disposed at the bottom wall part and cooling the cell.
